(19) United States
(12) Patent Application Publication
(10) Pub. No.: US 2008/0008445 A1
(43) Pub. Date: Jan. 10, 2008

(54) Broadcast recorder, broadcast recording/reproducing device, and broadcast recording/reproducing method

(75) Inventor: Takuji Kimura, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/819,915

(22) Filed: Jun. 29, 2007

(30) Foreign Application Priority Data
Jun. 29, 2006 (JP) 2006-179904

(51) Int. Cl. H04N 5/91

(52) U.S. Cl. 386/83

(57) ABSTRACT

According to one embodiment, there is provided a broadcast recorder including a tuner which, upon receipt of a broadcast signal, demodulates the signal, and outputs the signal as a reproducing signal, a monitor which monitors a receiving condition of the tuner and outputs a time-series recording condition checking signal, and a recorder which records the reproducing signal output from the tuner and the time-series recording condition checking signal output from the monitor in a recording area.

### CROSS-REFERENCE TO RELATED APPLICATIONS

This application is based upon and claims the benefit of priority from Japanese Patent Application No. 2006-179904, filed Jun. 29, 2006, the entire contents of which are incorporated herein by reference.

### BACKGROUND

1. Field

One embodiment of the invention relates to a broadcast recorder and a broadcast recording method for recording broadcast signals with a recording condition.

2. Description of the Related Art

In these days, a mobile device which can receive and record a TV broadcast has been developed and prevalent. When a receiving condition becomes worse than a predetermined level, such a mobile device cannot browse the information and, when a user wants to reproduce the information recorded in the period, nothing can be reproduced.

In Patent Document 1 (Jpn. Pat. Appln. KOKAI Publication No. 2006-50065), a technique about a mobile digital broadcast receiver is disclosed, in which when the broadcast receiver moves to another area after recording is reserved, it judges the area information and the identification ID, thereby avoiding such a recording failure as recording a program different from the reserved program.

The conventional technique of Patent Document 1, however, is not able to know the recording condition of a video file, recorded in the state that some parts of the recording condition become worse, until it is reproduced actually.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of a structure of a recording/reproducing device according to one embodiment of the invention;

FIG. 2 is an appearance view showing an example of an appearance of the recording/reproducing device according to the embodiment of the invention;

FIG. 3 is an explanation view showing an example of a table showing a recording condition of the recording/reproducing device according to the embodiment of the invention;

FIG. 4 is an explanation view showing an example of a screen showing the table showing the recording condition of the recording/reproducing device according to the embodiment of the invention;

FIG. 5 is an explanation view showing an example of an MPEG2TS-type file showing the recording condition of the recording/reproducing device according to the embodiment of the invention;

FIG. 6 is an explanation view showing an example of a recording condition file showing the recording condition of the recording/reproducing device according to the embodiment of the invention;

FIG. 7 is an explanation view showing an example of recording condition monitoring processing of the recording/reproducing device according to the embodiment of the invention;

FIG. 8 is an explanation view showing an example of detecting processing of a PMT and a NIT of the recording condition monitoring processing of the recording/reproducing device according to the embodiment of the invention;

FIG. 9 is an appearance view showing an example of appearance of a cell phone which performs the recording condition monitoring processing according to the embodiment of the invention; and

FIG. 10 is a block diagram showing an example of a structure of the cell phone which performs the recording condition monitoring processing according to the embodiment of the invention.

### DETAILED DESCRIPTION

Various embodiments according to the invention will be described hereinafter with reference to the accompanying drawings. In general, according to one embodiment of the invention, there is provided a broadcast recorder, a broadcast recording/reproducing device, and a broadcast recording/reproducing method capable of previously knowing the recording condition of a video file before reproduction.

One embodiment for solving the problem is a broadcast recorder comprising a tuner which receives the broadcast signals, demodulates them, and outputs them as reproducing signals, a monitor which monitors the receiving condition of the tuner and outputs a time-series recording condition checking signal, and a recorder which records the reproducing signal output from the tuner and the recording condition checking signal output from the monitor in a recording area.

Owing to the above, there are provided a broadcast recorder, a broadcast recording/reproducing device, and a broadcast recording/reproducing method capable of notifying in time series the recording condition of the video file already recorded through displaying a table before the reproduction.

Hereinafter, an embodiment of the invention will be described in detail referring to the drawings.

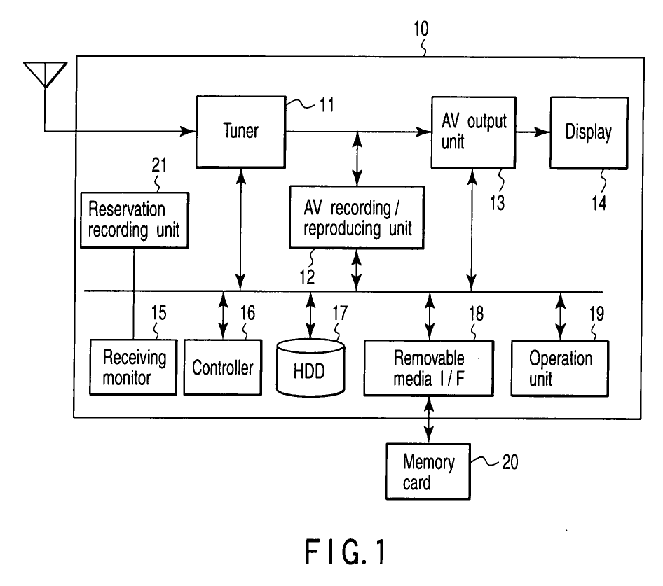

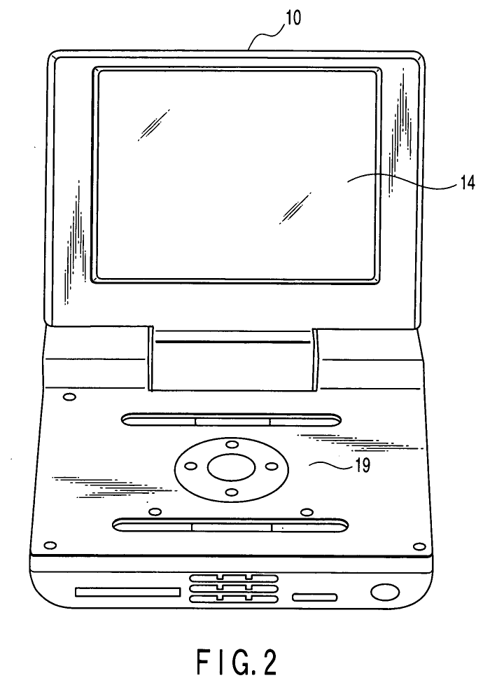

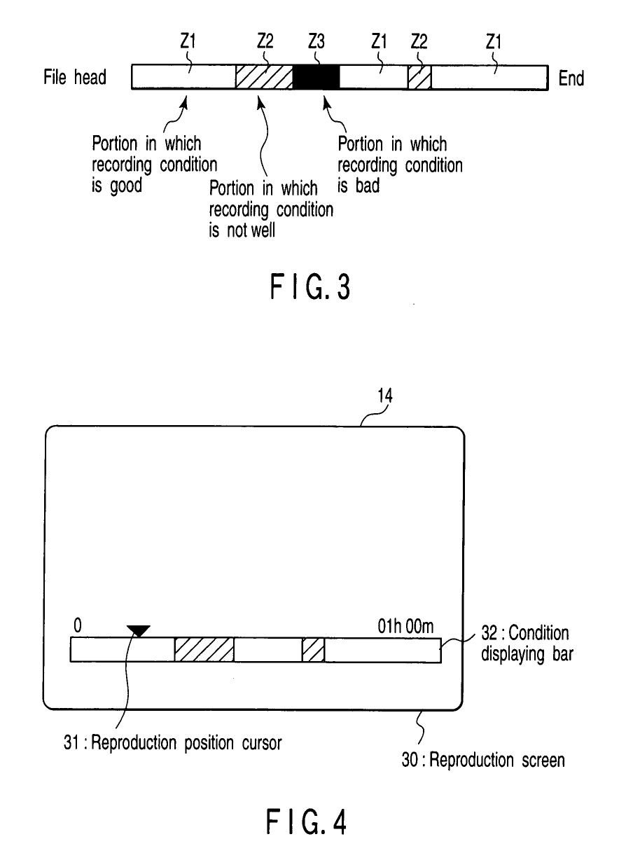

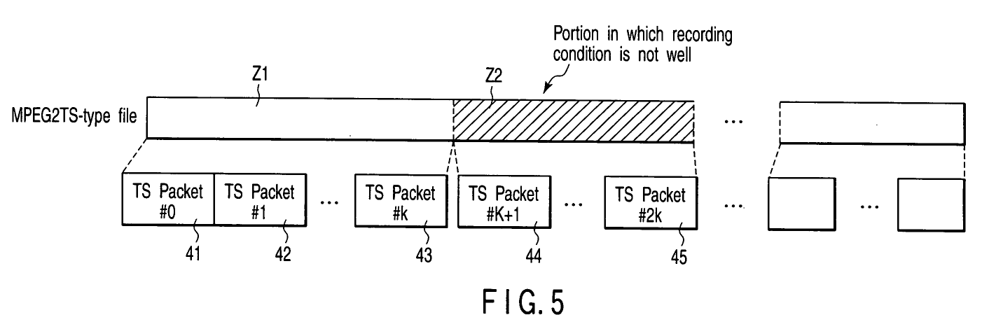

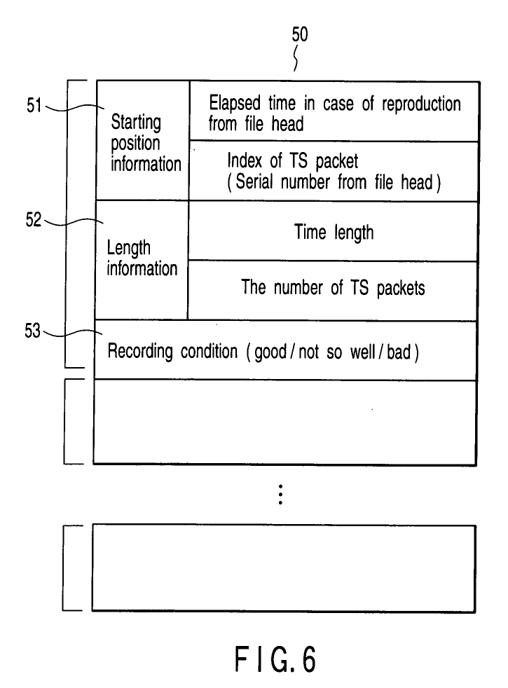

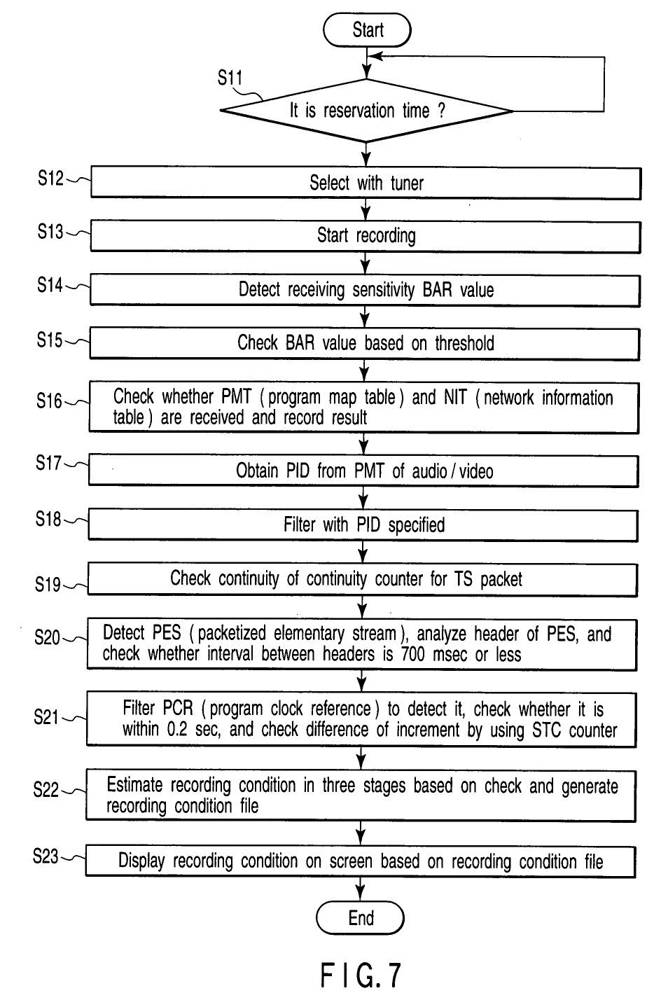

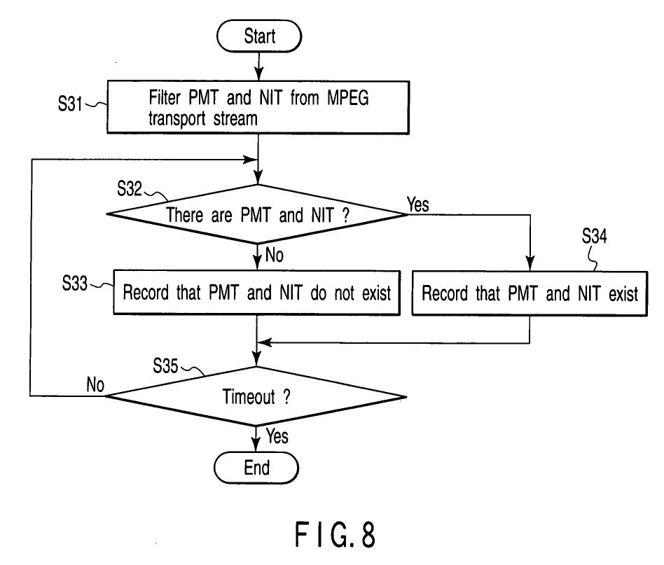

FIG. 1 is a block diagram showing an example of a structure of the recording/reproducing device according to the embodiment of the invention. FIG. 2 is an appearance view showing an example of an appearance of the recording/reproducing device according to the embodiment of the invention. FIG. 3 is an explanation view showing an example of a table showing a recording condition of the recording/reproducing device according to the embodiment of the invention. FIG. 4 is an explanation view showing an example of a screen showing the table showing the recording condition of the recording/reproducing device according to the embodiment of the invention. FIG. 5 is an explanation view showing an example of a MPEG2TS-type file showing the recording condition of the recording/reproducing device according to the embodiment of the invention. FIG. 6 is an explanation view showing an example of a recording condition file showing the recording condition of the recording/reproducing device according to the embodiment of the invention. FIG. 7 is an explanation view showing an example of recording condition monitoring of the recording/reproducing device according to the embodiment of the invention. FIG. 8 is an explanation view showing an example of detection of a PMT and a NIT of the recording condition monitoring of the recording/reproducing device according to the embodiment of the invention.

<Broadcast Recording/Reproducing Device according to One Embodiment of the Invention>

(Structure)

An example of the broadcast recording/reproducing device according to the embodiment of the invention is preferred to be a mobile device having a recording function and a reproducing function of TV broadcast signals, but it is not limited to this. Hereinafter, a description will be specifically made by using the drawings in the case of the mobile device having the recording function and the reproducing function of the TV broadcast signals.

As shown in FIG. 1, a mobile device 10, that is, the broadcast recording/reproducing device according to the embodiment of the invention comprises: a tuner 11 which has a function for receiving digital television signals and analog television signals; an AV recording/reproducing unit 12 which has, for example, a MPEG encoder/decoder function; an AV output unit 13 having a video processing unit and an audio processing unit; and a display 14 such as a liquid crystal display.

In addition, as shown in FIG. 1, the mobile device 10 that is the broadcast recording/reproducing device according to the embodiment of the invention comprises: a receiving monitor 15 which has a function of monitoring the recording condition described later; a controller 16 which controls the whole operation; an HDD 17 which is a recording area for storing a video file; a removable media I/F 18 that is an interface such as a removable memory card 20; an operation unit 19 which has various operation switches and a remote control interface function; and a reservation recording unit 21 which registers a recording reservation and performs the recording according to the reservation.

(Operation)

In the mobile device 10, that is, the broadcast recording/reproducing device having the above structure, the tuner 11 receives a television broadcast such as a digital broadcast and an analog broadcast, and the received signals are supplied to the recording/reproducing unit 12 and recorded in the HDD 17, according to an operation instruction from the operation unit 19. Alternatively, the received signals may be supplied to the AV output unit 13, the video output from the AV output unit 13 may be supplied to the display 14, the video may be displayed on the display 14, and the audio signals supplied from the AV output unit 13 may be supplied to a speaker not-illustrated, thereby making it possible for a user to watch a television broadcast.

In the same way, in the mobile device 10, that is, the broadcast recording/reproducing device, according to the operation instruction from the operation unit 19, the video file recorded in the HDD 17 is decoded by the AV recording/reproducing unit 12 and passes through the AV output unit 13, the video of the recorded file is displayed on the display 14, and the audio of the recorded file is reproduced by the speaker, with the result that a user can watch the recorded file.

(Monitoring Function)

As shown in FIG. 4, the mobile device 10 that is the broadcast recording/reproducing device has the monitoring function for checking, recording, and displaying the recording condition of the video file under recording in order to notify a user of the recording condition.

Taking the case of performing recording processing by the reservation recording as an example, the monitoring function will be described in detail referring to the flow charts of FIGS. 7 and 8. The monitoring function according to the embodiment is not restricted to the case of recording by the reservation recording processing, but it can be realized similarly in the case of recording manually. In the following description, although the function is described with the mobile device having a display function, the same function can be realized also in a device having only a recording function and a device having a recording function and a reproducing function but not having a display unit, in the same spirit as described below.

At first, as shown in the flow chart of FIG. 7, when the reservation time corresponding to the predetermined reservation information set by the reservation recording unit 21 of FIG. 1 has come (Step S11), the tuner 11 selects a channel according to the reservation information, demodulates the broadcast signals, and supplies the audio and video signals to the AV recording/reproducing unit 12 through the operations of the controller 16 and the reservation recording unit 21 (Step S12). The recording processing starts (Step S12), by supplying the audio and video signals encoded by the AV recording/reproducing unit 12 to, for example, the HDD 17.

At this time, as described below, many receiving parameters are obtained from the receiving signals in order to detect the receiving condition and the recording condition owing to the operations of the controller 16 and the receiving monitor 15. As a main example, the case of using the following five indicators will be described, although the receiving parameters are not limited to these examples.

At first, as a first indicator, a receiving sensitivity BAR value is detected from the receiving signals supplied from the tuner 11. The receiving sensitivity BAR value simply indicates the size of the receiving signal, and judges the recording condition based on the receiving condition by comparison between the BAR value and a predetermined threshold (Step S14).

As a second indicator, the receiving condition and the recording condition are judged by the operation of the receiving monitor 15 based on whether the PMT (Program Map Table) and the NIT (Network Information Table) included in the receiving signals have been received or not (Step S16). The PMT and the NIT are to be transferred periodically and whether they have been received periodically for sure is to be checked.

Here, the concrete monitoring processing of the PMT and NIT receiving condition will be described by a subroutine shown in FIG. 8. That is, in the flow chart shown in FIG. 8, the receiving monitor 15 filters the MPEG transport stream for the PMT and the NIT (Step S31) and checks whether there are the PMT or NIT (Step S32). When there is neither PMT nor NIT, the absence of the PMT and NIT is recorded into the recording region (Step S33). In the same way, when there are the PMT and the NIT, the presence of the PMT and NIT is recorded into the recording region (Step S34). Such operations are performed at intervals of the predetermined time till the timeout comes (Step S35).

Owing to the operations, a record about whether the PMT and the NIT which should normally exist at the predetermined time exist actually or not, can be left and the recording condition based on the receiving condition is judged based on this record.

As a third indicator, continuity of a continuity counter is checked for every TS packet (Step S19). As a procedure for this, PID is obtained from the PMT of the audio video (Step S17). The PID is specified to perform the filtering (Step S18) so that the continuity of the continuity counter is checked for every TS packet. That is, when the TS packet is received normally, the continuity counter shows the stable continuity and whether it is received normally is determined by whether the counter value maintains the continuity to be stable in the range of a predetermined value.

As a fourth indicator, PES (Packetized Elementary Stream) is determined, a header of the PES is analyzed, and whether a space between the headers is 700 msec or less is checked (Step S20). That is, when the receiving condition is unstable, the space between the headers of the PES often becomes, for example, 700 msec or less.

That is, when the receiving condition is unstable, some TS packets fail to be received. As a result, the detected header space of the PES often becomes, for example, longer than 700 msec. Therefore, by checking whether the header space is 700 msec or less, it is checked whether the TS packet is received normally.

As a fifth indicator, filtering is performed to detect PCR (program clock reference), and it is checked whether the PCR is within 0.2 sec or not. Further, a difference of the increment is checked by an STC counter. The PCR is a reference clock for synchronization indicating the timing at which the broadcast station supplies the signals and it is preferable that the increment condition of the PCR is checked whether the signal may be received at the predetermined intervals and whether the operation is performed in agreement with the STC counter.

Total Judgment

For example, the receiving monitor 15 and the controller 16 perform the total judgment based on the five indicators, thereby checking the receiving condition of the tuner 11 and the recording condition at the time. However, it is not always necessary to check the receiving condition and the recording condition by the total judgment based on the five indicators, but one or one portion of these indicators may be used or another indicator may be also used.

Based on the check, the recording condition is estimated, for example, in three grades and the recording condition file is generated (Step S22). That is, as shown in FIG. 3, it may be estimated in the three grades: a portion Z1 in which the recording condition is good, a portion Z2 in which the recording condition is not so well, and a portion Z3 in which the recording condition is bad, hence to generate the recording condition file.

As shown in FIG. 5, the recording condition file is preferably a file of a MPEG2TS type having the packets 41 to 45 corresponding to the portions Z1 to Z3 respectively. As shown in FIG. 6, the recording condition file 50 is preferred to have information such as “starting position information 51”, “length information 52”, and “recording condition 53”.

The receiving monitor 15 and the controller 16 store the recording condition file 50 having such a format in the recording region while performing the video recording processing.

In the stage of reproduction, upon receipt of the operational instruction for reproduction from the operation unit 19 or simply upon receipt of the operational instruction for monitor display of the recording condition, a condition display table 32 corresponding to the recording condition file 50 is displayed in a reproduction screen displayed on the operation screen or the display 14 as shown in FIG. 4.

The condition display table 32 is to display the recorded reproducing signals from the head to the end of the recording time in a table and displays the recording condition, for example, in the three grades in a graphically distinguishable way on the reproduction screen 30, for example. It is preferred to show a position being displayed by using a reproduction position cursor 31.

At this time, by pushing a skip button not-illustrated at the time of reproduction according to the display sections of the condition display table 32 through the operations of the receiving monitor 15 and the controller 16, it is preferred to skip the portion Z2 in which the recording condition is so not well and the portion Z3 in which the recording condition is bad.

As mentioned above, in the embodiment, a user can know the recording condition at the stage of starting the reproduction, without necessity for reproducing the whole recorded file to know the recording condition. Therefore, efficient reproduction processing can be performed according to the recording condition.

<Cell Phone Device which Performs the Recording Condition Monitoring Processing According to One Embodiment of the Invention>

The above-mentioned recording condition monitoring processing is realized not only by the mobile device but also by a cell phone (mobile communication device) M in which a so-called television reproducing function is mounted. Hereinafter, an example in the case of using the above monitoring processing in the cell phone with the television reproducing function mounted will be described in detail referring to the drawings.

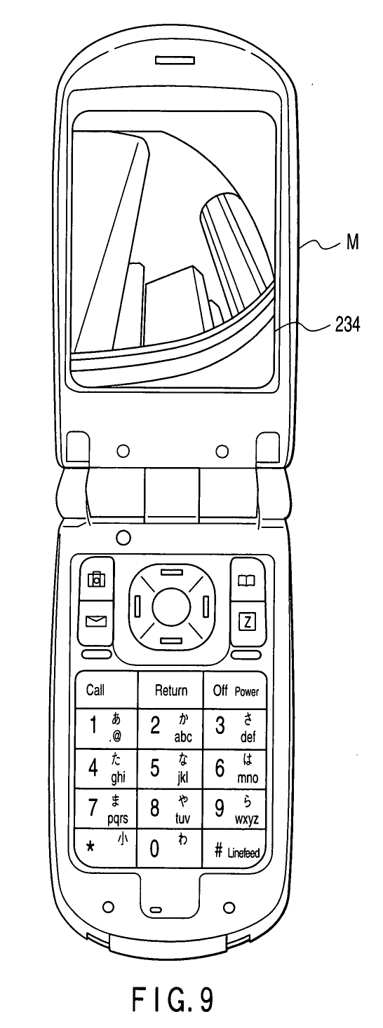

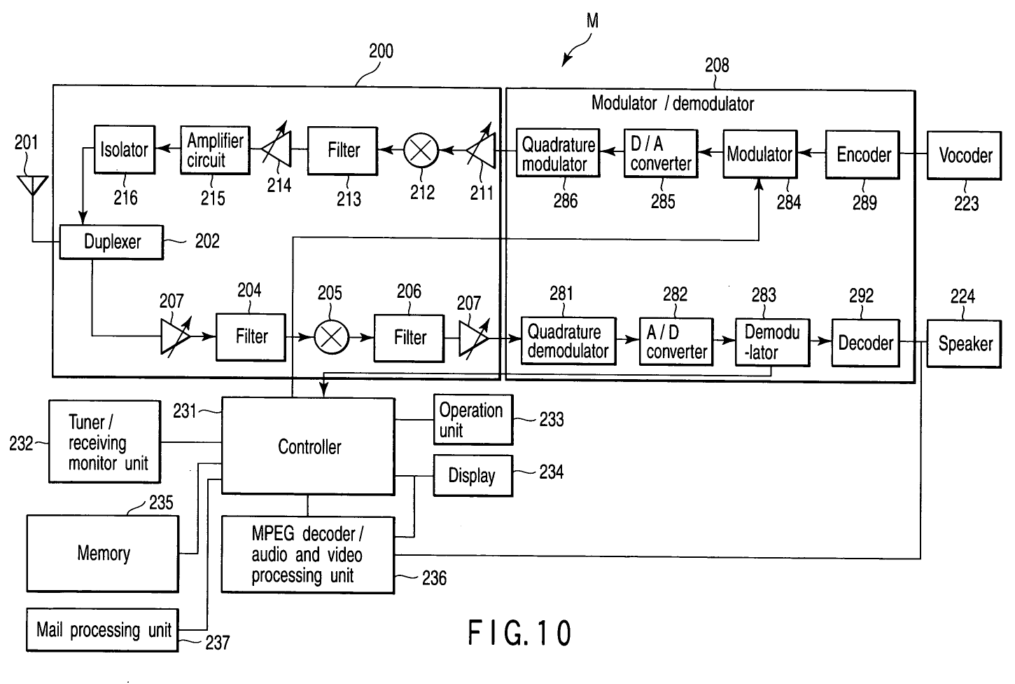

FIG. 9 is an appearance view showing an example of the appearance of the cell phone which performs the recording condition monitoring processing according to the embodiment of the invention. FIG. 10 is a block diagram showing an example of the structure of the cell phone which performs the recording condition monitoring processing according to the embodiment of the invention.

(Structure and Operation)

The cell phone device that is the embodiment of the invention will be described by using FIGS. 9 and 10. The cell phone device (mobile communication device) M includes a communication unit 200, an antenna 201, a duplexer 202, an RF receiving gain variable amplifier 203, an RF band limiting filter 204, a frequency converter 205, an IF band limiting filter 206, an IF receiving gain variable amplifier 207, a modulating/demodulating unit 208, an IF transmitting gain variable amplifier 211, a frequency converter 212, an RF band limiting filter 213, an RF transmitting gain variable amplifier 214, an electric power amplifier 215, an isolator 216, a vocoder 223, and a speaker 224.

In the mobile communication device M, a controller 231 which controls the whole operation is connected to a tuner/receiving monitor 232, an operation unit 233 which has a plurality of switches, a display unit 234 which displays the operation information and a photo image, a memory 235 which records moving image contents and program reservation information, an MPEG decoder/audio and video processing unit 236, and a mail processing unit 237. Outputs of the MPEG decoder/audio and video processing unit 236 are connected to the display unit 234 and the speaker 224 respectively.

The modulating/demodulating unit 208 includes a quadrature demodulator 281, an A/D converter 282, an information signal demodulator 283, and a decoder 292. It further includes an encoder 289 which encodes the signal from the vocoder 223, an information signal modulator 284, a D/A converter 285, and a quadrature modulator 286. In this structure, the signal quadrature-demodulated by the quadrature demodulator 281 is A/D-converted by the A/D converter 282, and the signal information is demodulated by the signal demodulator 283, decoded by the decoder 292, and output.

The receiving processing in the mobile communication device M having this structure will be described. A forward link signal transmitted from a base station is received by the antenna 201, supplied to a circuit at a receiver side by the duplexer 202, amplified or attenuated by the RF receiving gain variable amplifier 203, filtered for unnecessary components by the RF band limiting filter 204, frequency-converted from the RF band to the IF band by the frequency converter 205, filtered for unnecessary components by the IF band limiting filter 206, amplified or attenuated by the IF receiving gain variable amplifier 207, and supplied to the modulating/demodulating unit 208.

The modulating/demodulating unit 208 is formed by the quadrature demodulator 281, the A/D converter 282, the information signal demodulator 283, the information signal modulator 284, the D/A converter 285, and the quadrature modulator 286.

The encoder 289 and the decoder 292 are preferred to be encoded and decoded by the same encryption key information, hence to prevent illegal listening to the sound information communicated in the phone, thanks to the encoding processing. Strictly speaking, however, the encryption key information to be encrypted from a mobile communication unit at the transmitting side and the key information of the decoder 292 at the receiving side have to be the same.

The receiving processing of the mobile communication device M having this structure will be described below. According to the display of the operation information on the display unit 234, it replies to the operation information supplied from the operation unit 233 by a user and performs the following operations according to the operation control of the controller 231. That is, the signal quadrature-demodulated by the quadrature demodulator 281 is A/D converted by the A/D converter 282, the signal information is demodulated by the signal demodulator 283, decoded by the decoder 292, and supplied to the speaker 224 as sound.

The transmitting processing of the mobile communication device M will be described below. In the same way as the above, according to the display of the operation information of the display unit 234, it replies to the operation information supplied from the operation unit 233 by a user and performs the following operations according to the operation control of the controller 231. That is, a reverse link signal transmitted from the mobile station is supplied through the vocoder 223 and encoded by the encoder 289. The encoded signal is modulated and output by the information signal modulator 284, D/A converted by the D/A converter 285, quadrature-modulated by the quadrature modulator 286, amplified or attenuated by the IF transmitting gain variable amplifier 211, frequency-converted from the IF band to the RF band by the frequency converter 212, filtered for unnecessary components by the RF band limiting filter 213, amplified or attenuated by the RF transmitting gain variable amplifier 214, amplified by a power amplifier 215, supplied to the antenna 201 by the duplexer 202 through the isolator 216, and transmitted to spaces.

Monitoring Function

In the so-called cell phone, by mounting the tuner function as the tuner/receiving monitor 232, a desired broadcast program is selected according to the operation signal from the operation unit 233 and it becomes possible to see and hear this audio and video.

Further, since the memory 235 is included, it is possible not only to see and hear the television broadcast by using the tuner 232, but also to record the audio and video signal corresponding to the broadcast signal in the memory 235.

The function for recording and displaying the recording condition according to the receiving condition described above is obtained by the receiving monitor 232 at the same time. Owing to this, a user can know the recording condition at the stage of starting the reproduction, without necessity for reproducing the whole recorded file to know the recording condition. Therefore, the efficient reproducing according to the recording condition can be performed.

Owing to the various embodiments described above, those skilled in the art may realize the invention. Further, it is easy for those skilled to find an idea of various modifications of these embodiments and it is possible to apply the invention to various embodiments without the inventive ability. Therefore, the invention is applied in a wide range which does not conflict with the principle and novel characteristic which are disclosed and not limited to the above-mentioned embodiments.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A broadcast recorder comprising:
a tuner which, upon receipt of a broadcast signal, demodulates the signal, and outputs the signal as a reproducing signal;
a monitor which monitors a receiving condition of the tuner and outputs a time-series recording condition checking signal; and
a recorder which records the reproducing signal output from the tuner and the recording condition checking signal output from the monitor in a recording area.

2. The broadcast recorder according to claim 1, further comprising:
a display unit which, upon receipt of a instruction signal, displays the time-series recording condition on a screen, according to the recording condition checking signal.

3. The broadcast recorder according to claim 1, wherein the recording condition checking signal is to display a recorded reproducing signal from a head to an end of a recording time in a table and display the recording condition in plural stages in a graphically distinguishable way.

4. The broadcast recorder according to claim 1, wherein the monitor judges a receiving condition by detecting a BAR value from the receiving signal of the tuner and making a comparison between the BAR value and a predetermined value and outputs the time-series recording condition checking signal.

5. The broadcast recorder according to claim 1, wherein the monitor detects a PMT and NIT from the receiving signal of the tuner, checks the receiving condition based on whether at least one of the above signals is received periodically, and outputs the time-series recording condition checking signal.

6. The broadcast recorder according to claim 1, wherein the monitor detects a continuity counter of a TS packet from the receiving signal of the tuner, checks the receiving condition based on the continuity of the counter value, and outputs the time-series recording condition checking signal.

7. The broadcast recorder according to claim 1, wherein the monitor detects a header of a PES from the receiving signal of the tuner, checks the receiving condition based on whether an interval between each header is 700 msec or less, and outputs the time-series recording condition checking signal.

8. The broadcast recorder according to claim 1, wherein the monitor detects a counter of a PCR from the receiving signal of the tuner, checks the receiving condition based on a difference of increment of the counter value, and outputs the time-series recording condition checking signal.

9. A broadcast recording/reproducing device comprising:
a tuner which, upon receipt of a broadcast signal, demodulates the signal, and outputs the signal as a reproducing signal;
a monitor which monitors a receiving condition of the tuner and outputs a time-series recording condition checking signal;
a recorder which records the reproducing signal output from the tuner and the time-series recording condition checking signal output from the monitor in a recording area; and
a display which, upon receipt of a reproducing instruction signal, displays a time-series recording condition from a head to an end of a recording time of the reproducing signal being recorded, on a screen with a table in a graphically distinguishable way in a plural stages according to the recording condition checking signal, and reproduces the reproducing signal recorded by the recorder to display the signal.

10. The broadcast recording/reproducing device according to claim 9, wherein the monitor judges the receiving condition by detecting a BAR value from the receiving signal of the tuner and making a comparison between the BAR value and a predetermined value and outputs the time-series recording condition checking signal.

11. The broadcast recording/reproducing device according to claim 9, wherein the monitor detects a PMT and NIT from the receiving signal of the tuner, checks the receiving condition based on whether the these signals are surely included, and outputs the time-series recording condition checking signal.

12. The broadcast recording/reproducing device according to claim 9, wherein the monitor detects a continuity counter of a TS packet from the receiving signal of the tuner, checks the receiving condition based on the continuity of the counter value, and outputs the time-series recording condition checking signal.

13. The broadcast recording/reproducing device according to claim 9, wherein the monitor detects a header of a PES from the receiving signal of the tuner, checks the receiving condition based on whether an interval between each header is 700 msec or less, and outputs the time-series recording condition checking signal.

14. The broadcast recording/reproducing device according to claim 9, wherein the monitor detects a counter of a PCR from the receiving signal of the tuner, checks the receiving condition based on a difference of increment of the counter value, and outputs the time-series recording condition checking signal.

15. A broadcast recording/reproducing method comprising:
receiving a broadcast signal, demodulating the signal, and outputting the signal as a reproducing signal;
monitoring a receiving condition of the broadcast signal and outputting a time-series recording condition checking signal;
recording the reproducing signal and the time-series recording condition checking signal in a recording area; and
displaying a time-series recording condition from a head to an end of a recording time of the reproducing signal recorded, on a screen with a table in a graphically distinguishable way in plural stages according to the recording condition checking signal and reproducing the reproducing signal.

16. The broadcast recording/reproducing method according to claim 15, wherein, by detecting a BAR value from the receiving signal of the broadcast signal and making a comparison between the value and a predetermined value, the receiving condition is checked and the time-series recording condition checking signal is output.

17. The broadcast recording/reproducing method according to claim 15, wherein a PMT and a NIT are detected from the receiving signal of the broadcast signal, the receiving condition is checked based on whether at least one of the signals is received periodically, and the time-series recording condition checking signal is output.

18. The broadcast recording/reproducing method according to claim 15, wherein a continuity counter of a TS packet is detected from the receiving signal of the broadcast signal, the receiving condition is checked based on the continuity of the counter value, and the time-series recording condition checking signal is output.

19. The broadcast recording/reproducing method according to claim 15, wherein a header of a PES is detected from the receiving signal of the broadcast signal, the receiving condition is checked based on whether an interval between each header is 700 msec or less, and the time-series recording condition checking signal is output.

20. The broadcast recording/reproducing method according to claim 15, wherein a counter of a PCR is detected from the receiving signal of the broadcast signal, the receiving condition is checked based on a difference of increment of the counter value, and the time-series recording condition checking signal is output.
